(19) United States
(12) Patent Application Publication
(10) Pub. No.: US 2019/0293189 A1
(43) Pub. Date: Sep. 26, 2019

(54) STOP VALVE, SCR SYSTEM, AND METHOD FOR DETECTING LEAKS AND/OR IDENTIFYING VARIATIONS IN METERED AMOUNTS

(71) Applicant: Robert Bosch GmbH, Stuttgart (DE)

(72) Inventors: Okke Venekamp, Stephanskirchen (DE); Chen Zhou, Benningen Am Neckar (DE)

(21) Appl. No.: 16/302,745

(22) PCT Filed: Mar. 24, 2017
(86) PCT No.: PCT/EP2017/057075

§ 371 Date: Nov. 19, 2018

(30) Foreign Application Priority Data
May 19, 2016 (DE) 10 2016 208 600.6

(51) Int. Cl. F16K 7/16; F16K 31/06; G01M 3/26; F01N 3/20; F01N 11/00

(52) U.S. Cl. CPC F16K 7/16; F16K 31/0672; G01M 3/26; F01N 2900/1808; F01N 11/00; F01N 2550/05; F01N 2610/148; F01N 3/2066

(57) ABSTRACT

A stop valve (100) comprises a magnetic yoke (101), a solenoid coil (102), a compression spring (107) and an armature (105) on which an elastic membrane (106) is arranged. The membrane (106) can be sealingly pressed onto at least one fluid connection (108, 109). Furthermore, the compression spring (107) is positioned in such a way as to surround the edge of the lateral surface of the armature (105), and the solenoid coil (102) is positioned in such a way as to be enclosed by the compression spring (107). A method for detecting leaks and/or identifying variations in metered amounts is carried out in an SCR system comprising the stop valve (100) and involves opening the stop valve (100). A pressurized line is then filled with reducing agent and the stop valve (100) is closed. A pressure is subsequently reduced upstream of the stop valve (100) by shutting off a pump. Finally, any leak is detected and/or variations in the metered amount are identified by having the pressure sensor monitor the pressure downstream of the stop valve (100).

### BACKGROUND OF THE INVENTION

The present invention concerns a stop valve. The invention furthermore concerns an SCR system which comprises this stop valve, and a method for detecting leaks and/or identifying variations in metered amounts in said SCR system. In addition, the present invention concerns a computer program which executes each step of the method when run on a computer device, and a machine-legible storage medium which stores the computer program. Finally, the invention concerns an electronic control unit which is configured to execute the method.

Stop valves are used to control movements of fluids. In open state, they predefine the flow direction of the fluid, and in closed state prevent the movement of the fluid. Stop valves are used today in SCR systems to control the movement of a reducing agent (AdBlue®). In particular, stop valves are arranged in a pressure line of the SCR system between a delivery module and a metering module. There they prevent a leakage of the reducing agent into the pressure line; otherwise, there is a possibility that this would freeze and damage sensitive components.

One example of a stop valve as described above is given in publication DE 10 2011 090 070 A1. This concerns a stop valve used in an SCR system. This is a 2/2-way directional control valve in which a diaphragm valve, by means of a diaphragm spring, is pressed onto a diaphragm. The passage state is controlled via a solenoid coil and can thus remain open automatically when the minimum pressure is achieved in the flow direction in the system. In closed state, or with the diaphragm valve closed, the stop valve prevents leakage.

Publication DE 10 2012 204 104 A1 also concerns a stop valve which is arranged in a device for purging an exhaust gas aftertreatment system. Here, the stop valve is arranged in a delivery line between the delivery module and the metering module. The 2/2-way valve is actuated hydraulically via an actuator, and therefore no magnet is required. A control line branches off the delivery line and is used to control the actuator. When, in delivery mode, a positive pressure prevails in the delivery line, the actuator is actuated and opens the valve.

Publication DE 10 2012 211 112 A1 also discloses a stop valve used in an SCR system. In this system, an additional switch valve ensures the switching between delivery mode and return mode. This stop valve consists of a changeover valve and a 2/2-way valve. The changeover valve opens the 2/2-way valve at two different pressure levels. As a result, the stop valve can be opened both in delivery mode and in return mode.

Publication DE 10 2012 209 689 A1 describes an arrangement for exhaust gas aftertreatment by means of SCR. Here, a delivery module and a stop valve are described. The stop valve prevents leakage by means of a shut-off element. This is achieved by a sealing ram which lies tightly on the sealing seat in closed state. The open state is achieved using a bistable spring element which presses the sealing ram against the contact face with low holding force. The bistable spring element here ensures a high closing force and a low holding force. This allows use of the valve without active deployment, so that the valve can be used preferably passively in this arrangement.

### SUMMARY OF THE INVENTION

A stop valve is proposed which is configured to control a fluid movement. In particular, when it assumes a blocking mode, the stop valve prevents a movement of the fluid and a leakage. To this end it comprises a magnet yoke, a solenoid coil, a compression spring and a solenoid armature. The solenoid armature may in particular be configured as a flat armature or a solenoid plunger. An elastic membrane is arranged on the solenoid armature, wherein the membrane can be pressed with sealing effect onto at least one fluid connection. The compression spring is arranged on the solenoid armature such that it runs around the edge of the casing surface of the solenoid armature. In other words, the compression spring surrounds the solenoid armature on its inside. Also, the coil is arranged such that it is surrounded by the compression spring. The compression spring thus encloses both the solenoid armature and the coil. This prevents tilting of the solenoid armature and the stop valve requires no additional guide components.

According to one aspect, this stop valve is used in an SCR system. The SCR system comprises a pump in a delivery module and a metering module which are connected together by a pressure line. The stop valve described above is arranged in the pressure line. Furthermore, the pressure line comprises a pressure sensor which is arranged between the stop valve and the metering module. This SCR system has the advantage that a basic leakage through pump gaps of a pump, which can deliver and siphon back by changing its direction of rotation, is prevented.

The stop valve is preferably configured so that it can assume the following modes. In a blocking mode, the membrane is pressed by the solenoid armature onto both a fluid inlet and a fluid outlet, and closes both tightly. This offers the advantage that in blocking mode, the stop valve ensures blockage against reduced pressure and positive pressure both from the fluid inlet and from the fluid outlet. Furthermore, a metering mode is provided in which the stop valve is opened hydraulically unpowered above a set pressure, and remains open because of the pressure. This means that no active deployment and hence no permanent powering is required in metering mode of the SCR system. In addition, a return mode is provided in which a magnetic force between the magnet yoke and the solenoid armature holds the stop valve in an open position. This allows a reducing agent to be siphoned back out of the pressure line of the SCR system.

A further aspect of the stop valve concerns an ice pressure protection of the SCR system. The freezing reducing agent leads to an ice pressure which can cause displacement of a volume. The membrane may be pressed in the direction of the valve interior at the fluid inlet without the stop valve being opened. This defines an ice pressure displacement volume.

The method for detecting leaks and/or identifying variations in metered amounts is used in in the SCR system, including stop valve, as described above. Here, the method comprises the following steps. Firstly, the stop valve opens so that the pressure line can be filled with reducing agent. Then the stop valve is closed and a pressure downstream of the stop valve, i.e. between the stop valve and the metering module, is enclosed in the pressure line. The enclosed pressure is monitored by the pressure sensor. Now a pressure upstream of the stop valve, i.e. between the stop valve and the delivery module, is lowered by switching off the pump. In a further step, a leak detection and or identification of variations in metered amounts may be performed by monitoring the pressure downstream of the stop valve, as described above, by means of the pressure sensor.

Optionally, the stop valve may be closed by the spring force of the compression spring. This offers the advantage that the stop valve is closed automatically and also remains closed without the need for a power supply. The compression spring may also exert a force for pressing the membrane against a fluid inlet and a fluid outlet when the pressure is lowered upstream of the stop valve. In this way, simultaneous closure of both openings is achieved. This means that neither the reduced pressure from the pump upstream of the stop valve, nor the positive pressure from the enclosed pressure downstream of the stop valve, leads to an opening of the stop valve. Also, it is not necessary to supply the stop valve with power during leakage detection and/or identification of variations in metered amounts.

According to one aspect, when filling the pressure line with reducing agent, a first pressure is built up in the system. This lies in particular in a range between 5.8 bar and 10 bar. Then the pressure is reduced to a second pressure which in particular lies between 2 bar and 5.5 bar, whereupon the stop valve closes. This guarantees that the pressure throughout the SCR system is balanced. The pressure fall may be achieved for example via a choke or a check valve which connects a return with a portion of the pressure line upstream of the stop valve. The second pressure is thus enclosed in the pressure line between the stop valve and the metering module and may be used for leakage detection and/or identification of variations in metered quantities. Then, the pressure upstream of the stop valve is lowered to a third pressure of between 1 bar and 2 bar. This leads to a pressure difference between the fluid inlet and fluid outlet of the stop valve which causes a closure of the stop valve.

The leakage detection is preferably performed in that the enclosed pressure downstream of the stop valve (second pressure) is detected by the pressure sensor over a fixed time period from 0.5 to 30 seconds. If the enclosed pressure changes during this time period, a leakage in the pressure line or in the metering module can be concluded.

After leakage detection and/or identification of a variation in metered quantities, the pressure upstream of the stop valve, i.e. on the pump side, can again be increased to a fourth pressure. This may again lie in particular in a range between 4.8 bar and 10 bar. As a result, the SCR system is diagnosed and is suitable for metering.

The computer program is configured to perform each step of the method, in particular when executed on a computer or control unit. It allows implementation of the method in a conventional electronic control unit without the need to make structural changes thereto. For this, it is stored on the machine-legible storage medium.

By running the computer program on a conventional electronic control unit, the electronic control unit is obtained which is configured to perform a leakage detection and/or identification of variations in metered quantities.

### BRIEF DESCRIPTION OF THE DRAWINGS

Exemplary embodiments of the invention are shown in the drawings and explained in more detail in the description which follows.

FIG. 1 shows diagrammatically a stop valve according to one embodiment of the invention.

FIG. 2 shows diagrammatically a stop valve according to a further embodiment of the invention.

FIG. 3 shows diagrammatically an SCR system according to one embodiment of the invention.

FIG. 4 shows a flow diagram of an exemplary embodiment of the method according to the invention.

FIG. 5a shows a diagram of a pressure in a first portion of the pressure line in an SCR system according to one exemplary embodiment of the invention, over time.

FIG. 5b shows a diagram of a pressure in a first portion of the pressure line in an SCR system according to one exemplary embodiment of the invention, over time.

### DETAILED DESCRIPTION

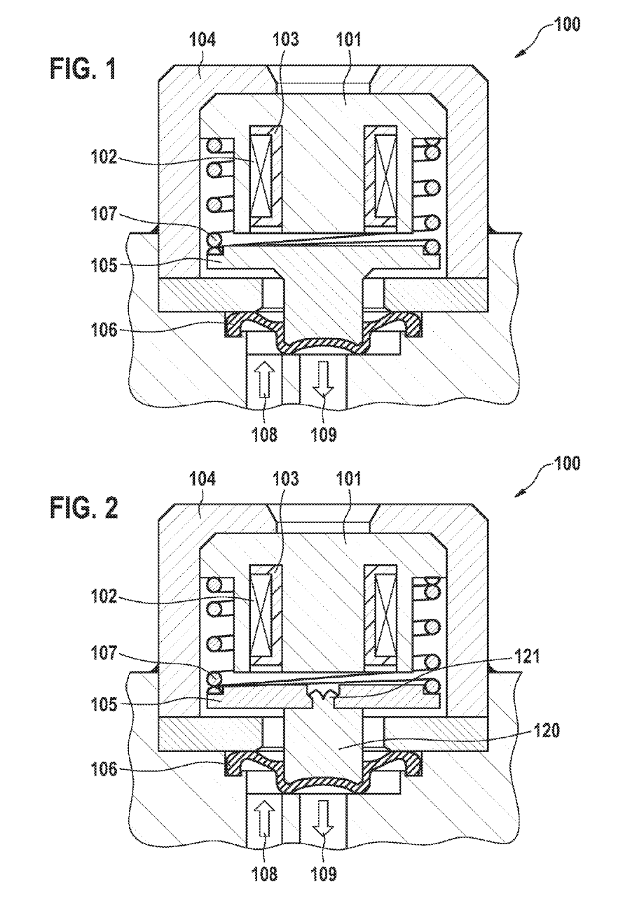

FIG. 1 shows a stop valve 100 according to a first exemplary embodiment of the invention. It comprises a magnet yoke 101 containing a solenoid coil 102 which is held by a coil carrier 103. The magnet yoke 101 and the coil carrier 103, including solenoid coil 102, are enclosed by a magnet housing 104. The stop valve 100 also comprises a flat armature 105 on which an elastic membrane 106 is arranged. The membrane 106 consists of HNBR (hydrogenated acrylonitrile butadiene rubber) and is sprayed or vulcanized onto the flat armature 105. The flat armature 105 is connected to one end of a compression spring 107 which runs around the edge of the casing surface of the flat armature 105. In a further embodiment, a solenoid plunger may be used instead of the flat armature 105. Another end of the compression spring 107 is connected to the magnet yoke 101 such that compression spring 107 surrounds the coil carrier 103, including solenoid coil 102, in its inside. A fluid inlet 108 and a fluid outlet 109 are arranged such that the membrane 106 can be pressed tightly sealing onto both and hence close both.

FIG. 2 shows a second exemplary embodiment of the stop valve 100 according to the invention. It comprises substantially the same components as described in FIG. 1, and these have substantially the same function. They are not therefore described again. The flat armature 105 in this embodiment is formed not as a unit but consists of two parts. One part is a membrane holder 120 on which the membrane 106 is sprayed or vulcanized. The membrane holder 120 is now connected to the flat armature 105 via a connection 121 by means of caulking. However, the connection 121 is not restricted to caulking and may also be achieved by welding or by a screw connection. This embodiment of the stop valve 100 is used if it proves difficult to spray or vulcanize the membrane 106 onto the flat armature 105, and it is easier to create the connection 121.

The stop valve 100, depending on conditions or use, may assume different modes. In a blocking mode, the compression spring 107 presses the flat armature 105 in the direction of the fluid inlet 108 and the fluid outlet 109, so that the membrane 106 closes both simultaneously. Thus the stop valve 100 is closed by the spring force of the compression spring 107 and no power supply is required. This prevents a fluid from being able to flow through the stop valve. The spring force of the compression spring 107 also holds the stop valve closed if a reduced or positive pressure is present at the fluid inlet 108 and/or fluid outlet 109, as long as this is sufficiently low, for example below 5.6 bar.

A further mode allows the fluid to flow from the fluid inlet to the fluid outlet. In this metering mode, a pressure p prevails in the fluid inlet 108 which presses against the membrane 106 and hence against the flat armature 105, and is sufficiently great that this overcomes the spring force of the compression spring 107. Thus the flat armature 105 is pressed in the direction of the magnet yoke 101, and a connection is created between the fluid inlet 108 and the fluid outlet 109. In the present exemplary embodiment, this pressure p amounts to 5.6 bar. In this mode too, no power supply is required. The membrane opens with the support of the pressure, and when a pressure p of 4 to 10 bar is present in the system, offers no pressure loss.

In addition, the stop valve 100 may assume a return mode by actuation of the solenoid coil 102. This provides a magnetic force between the magnet yoke 101 and the flat armature 105, which means that the flat armature 105 is drawn towards the magnet yoke 101 and the spring force of the compression spring 107 is overcome. Thus a connection is created or maintained between the fluid outlet 109 and the fluid inlet 108, through which the fluid can flow.

Since the membrane 106 is elastic, it is possible to deform this. Therefore, at the fluid inlet, it is possible to press the membrane 106 into the interior of the stop valve between the flat armature 105 and the magnet housing 104. However, in blocking mode, the membrane 106 still closes both the fluid inlet 108 and the fluid outlet 109. For this reason, only an additional volume is formed. This volume may be used if the fluid is a liquid which expands on freezing, in that it functions as an ice pressure displacement volume.

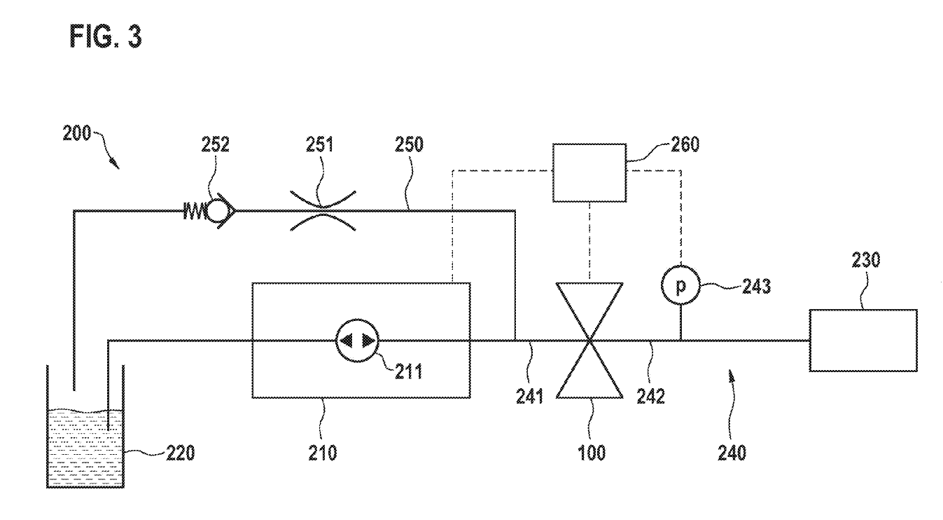

FIG. 3 shows an SCR system 200 which comprises the stop valve 100 according to the first or second exemplary embodiment. It also comprises a delivery module 210 with a pump 211 which is configured to deliver reducing agent from a reducing agent tank 220, and siphon it back into the reducing agent tank 220 by reversal of its rotation direction. The delivery module 210 is connected to a metering module 230 via a pressure line 240. The stop valve 100 is arranged in the pressure line 240 and divides this into two portions. A first portion 241 of the pressure line 240 is situated upstream of the stop valve 100, between this and the delivery module 210. A second portion 242 of the pressure line 240 lies downstream of the stop valve 100, between this and the metering module 230. Furthermore, a pressure sensor 243 is arranged in the second portion 242 of the pressure line 240, and monitors the pressure p in the second portion 242—and in some cases, when the stop valve 100 is opened, also in the first portion 241—of the pressure line 240. In addition, the SCR system comprises a return line 250 which connects the first portion 241 of the pressure line 240 to the reducing agent tank 220. A return choke 251 and a check valve 252 are arranged in this return line 250. In another embodiment, the return choke 251 or the check valve 252 may be removed. The stop valve 100, the pressure sensor 243 and the delivery module 210 are connected to an electronic control module 260 which controls them.

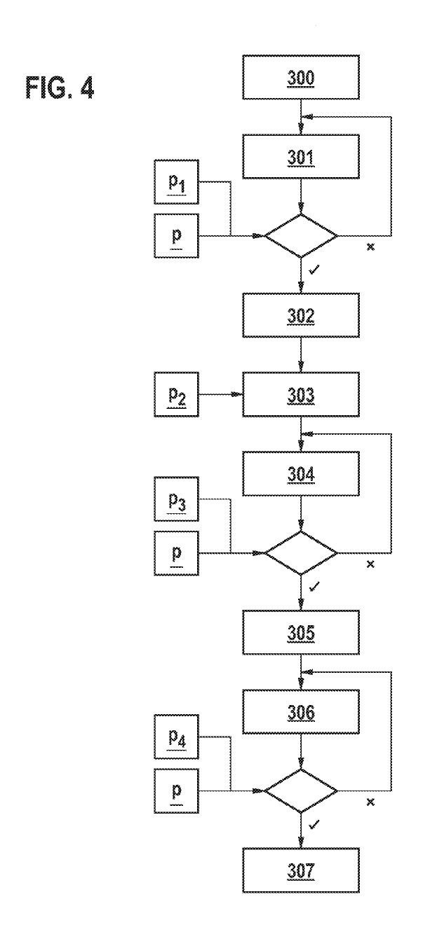

FIG. 4 shows a flow diagram of an exemplary embodiment of the method according to the invention for detecting leaks and/or identifying variations in metered quantities, as performed in the SCR system 200. The metering module 230 remains closed throughout the entire process. In a first step 300, the stop valve 100 opens. With the pump 211 switched off, the pressure line 240 fills 301 with reducing agent, whereby the pressure p in both parts 241 and 242 of the pressure line rises. When the pressure p in the entire pressure line 240 reaches a first pressure p₁ at 7 bar, the pump 211 is switched off 302. As a result, the pressure p in the pressure line 240 falls. When the pressure p now reaches a second pressure p₂ at 3.5 bar, the spring force of the compression spring 107 overcomes the pressure p, and the stop valve 100 closes 303. Thus the second pressure p₂ is enclosed in the second portion 242 of the pressure line 240. Then the pressure p in the first portion 241 of the pressure line 240 falls further 304 until a third pressure p₃ is reached at 1.5 bar.

A further step 305 follows in which a leakage is detected and/or a variation in metered quantities is identified. In leakage detection, the pressure p₂ enclosed in the second portion 242 of the pressure line 240 is observed over a predefined period of 10 seconds. If the pressure p falls during the observed period, some of the fluid must be escaping through one of the components of the metering module 230, pressure line 240, stop valve 100 or connecting pieces in between. Since the stop valve 100 is configured to prevent a leakage as far as possible, a leakage from the metering valve 230 and/or the pressure line 240 can be detected from this. Furthermore, via the pressure and the delivered quantity of reducing agent, a discrepancy between a desired metering quantity and the actual metering quantity, which is enclosed in the second portion 242 of the pressure line 240, can be identified.

After the leakage has been detected and/or the variation in metered quantities identified, in a further step 306 the pressure p in the first portion 241 of the pressure line 240 is increased again in that the pump 211 is switched on again. When the pressure p reaches a fourth pressure p₄, the stop valve 100 opens 307 again and the system is diagnosed and capable of metering.

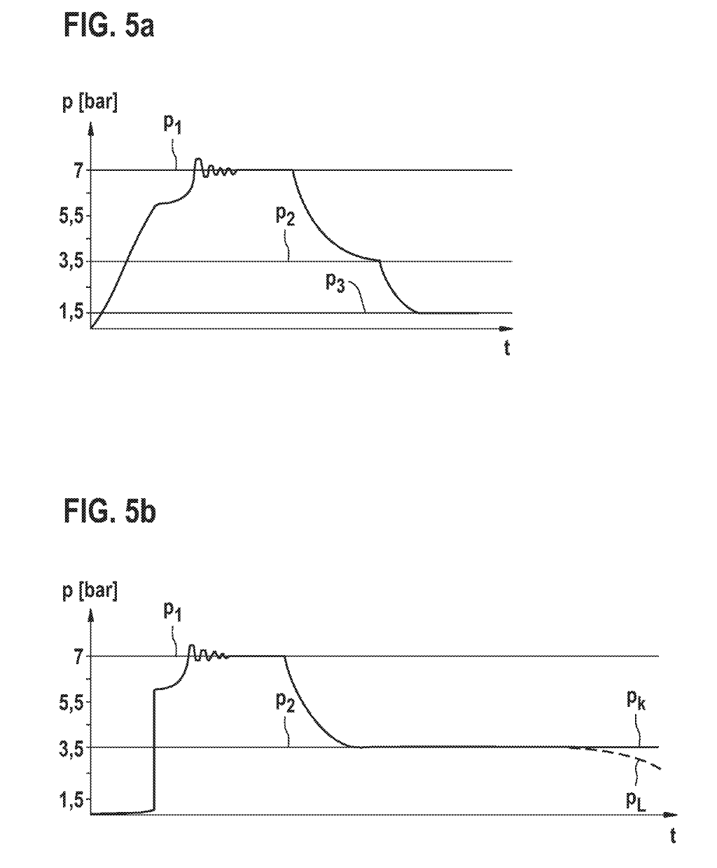

FIGS. 5a and 5b show diagrams depicting the pressure development in the first portion 241 and in the second portion 242 of the pressure line 240 over the time t. The stop valve 100 opens 300 at a pressure p of 5.6 bar. In the period between the opening 300 and closing 303 of the stop valve 100, at the second pressure p₂, the pressure development in the first portion 241 and second portion 242 of the pressure line 240 is the same in both figures. When the pressure pi of 7 bar is reached, a settling of this pressure p can be observed. This is attributable to the balancing of the pressure p in the entire pressure line 240. Then the pump 211 is switched off 302. The pressure falls to the second pressure p₂ which is 3.5 bar. At this second pressure p₂, the stop valve 100 closes as described above. The pressure development in the first portion 241, shown in FIG. 5a, now differs from the pressure development in the second portion 242 of the pressure line 240, shown in FIG. 5b. While the pressure p in the first portion 241 falls to a third pressure p₃ of 1.5 bar, the pressure initially remains constant. In FIG. 5b, two cases are depicted. Firstly, after reaching the second pressure p₂, the pressure remains at a constant pressure pₖ. Secondly, a fall in the pressure p towards a pressure p_{L} can be seen. From this fall in pressure p_{L} as described above, a leakage can be concluded.

1. A stop valve (100) comprising a magnet yoke (101), a solenoid coil (102), a compression spring (107) and a solenoid armature (105) on which an elastic membrane (106) is arranged, wherein the membrane (106) is configured to be pressed with sealing effect onto at least one fluid connection (108, 109), and the compression spring (107) runs around an edge of a casing surface of the solenoid armature (105), and the solenoid coil (102) is enclosed by the compression spring (107).

2. The stop valve as claimed in claim 1, characterized in that the solenoid armature is a flat armature or a solenoid plunger.

3. The stop valve as claimed in claim 1, wherein the stop valve is configured to assume the following modes:
a blocking mode in which the membrane (106) closes both a fluid inlet (108) and a fluid outlet (109);
a metering mode in which the stop valve (100) is opened hydraulically unpowered above a set pressure; and
a return mode in which a magnetic force between the magnet yoke (101) and the solenoid armature (105) holds the stop valve (100) in an open position.

4. The stop valve (100) as claimed in claim 1, characterized in that the membrane (106) defines an ice pressure displacement volume.

5. An SCR system (200) comprising a stop valve as claimed in claim 1, a pump (211) and a metering module (230) which are connected together by a pressure line (240), wherein the stop valve (100) is arranged in the pressure line (240), and a pressure sensor (243) is arranged in the pressure line (240) between the stop valve (100) and the metering module (230).

6. A method for detecting leaks and/or identifying variations in metered amounts in an SCR system as claimed in claim 5, wherein the stop valve (100) encloses a pressure (p) in the pressure line (240), the pressure being monitored by the pressure sensor (243), comprising the following steps:
opening (300) the stop valve (100);
filling (301) the pressure line (240) with reducing agent;
closing (303) the stop valve (100);
lowering (304) a pressure (p) upstream of the stop valve (100) by switching off (302) the pump (211); and
performing (305) a leak detection and/or identification of variations in metered amounts by monitoring the pressure (p) downstream of the stop valve (100) by means of the pressure sensor (243).

7. The method as claimed in claim 6, characterized in that the stop valve (100) is held closed by the spring force of the compression spring (107).

8. The method as claimed in claim 7, characterized in that a force which presses the membrane (106) against a fluid inlet (108) and a fluid outlet (109) is applied by the compression spring (107) when the pressure (p) is lowered (304) upstream of the stop valve (100).

9. The method as claimed in claim 6, characterized in that when filling (301) the pressure line (240) with reducing agent, a first pressure (p₁) is built up in the SCR system (200), the first pressure is then reduced to a second pressure (p₂) at which the stop valve (100) is closed, and then the pressure (p) upstream of the stop valve (100) is reduced to a third pressure (p₃) by switching off (302) the pump (211).

10. The method as claimed in claim 6, characterized in that to detect leaks, a fall in the enclosed pressure (p) downstream of the stop valve (100) over a fixed time span is detected by the pressure sensor (243).

11. The method as claimed in claim 6, characterized in that after leakage detection and/or identification of a variation in metered quantities, the pressure (p) upstream of the stop valve (100) is increased (306) to a fourth pressure (p₄), and the stop valve (100) is opened (307) when the fourth pressure (p₄) has been exceeded.

12. A non-transitory computer readable media comprising program code to perform each step of the method as claimed in claim 6.

13. (canceled)

14. An electronic control unit (260) which is configured to perform a leakage detection and/or identification of a variation in metered quantities by means of a method as claimed in claim 6.
